(19) United States
(12) Patent Application Publication
(10) Pub. No.: US 2023/0104261 A1
(43) Pub. Date: Apr. 6, 2023

(54) SINGLE INDUCTOR MULTIPLE OUTPUT REGULATOR AND CONTROL METHOD USING THE SAME

(71) Applicant: GEAR RADIO ELECTRONICS CORP., Hsinchu City (TW)

(72) Inventors: Wei-Jen CHANG, Taoyuan City (TW); Wei-Yu CHEN, New Taipei City (TW); Hao-Hung LO, Zhubei City, Hsinchu County (TW); Tsung-Ling LI, Hsinchu City (TW); Po-Hung CHEN, Zhubei City, Hsinchu County (TW)

(21) Appl. No.: 17/492,421

(22) Filed: Oct. 1, 2021

(51) Int. Cl. H02M 3/158; H02M 1/00

(52) U.S. Cl. CPC H02M 3/158; H02M 1/009

(57) ABSTRACT

A single inductor multiple output regulator includes an inductor, a number of capacitors, a number of switches coupled with the capacitors and a control circuit coupled with the switches and configured to apply at least two multi-switching pulses to a multi-pulse controlled one of the switches in each cycle.

### TECHNICAL FIELD

The disclosure relates in general to a single inductor multiple output regulator and a control method using the same.

### BACKGROUND

The conventional single inductor multiple output (SIMO) regulator includes a plurality of switches, wherein in each cycle, each switch is turned on once (single pulse), and one of the switches is turned on with a larger current if the larger output is required. As a result, a larger ripple will be outputted through the one of the switches, and the larger current will limit the choice of an inductor of SIMO. Therefore, how to improve the aforementioned conventional problems is one goal of the industry in this technical field.

### SUMMARY

According to an embodiment, a single inductor multiple output regulator includes an inductor, a plurality of capacitors, a plurality of switches coupled with the capacitors and a control circuit coupled with the switches and configured to apply at least two multi-switching pulses to a multi-pulse controlled one of the switches in each cycle.

According to another embodiment, a control method includes the following steps: providing a single inductor multiple output regulator, wherein the single inductor multiple output regulator comprises an inductor; a plurality of capacitors; a plurality of switches coupled with the capacitors; and a control circuit coupled with the switches; and applying, by the control circuit, at least two multi-switching pulses to a multi-pulse controlled one of the switches in each cycle.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 shows a functional block diagram of a single inductor multiple output regulator according to an embodiment of the present disclosure;

FIG. 2 shows a schematic diagram of various signal for the single inductor multiple output regulator of FIG. 1;

FIG. 3 shows a schematic diagram of various signal for the single inductor multiple output regulator of FIG. 1 according to another embodiment;

FIG. 4 shows a functional block diagram of a single inductor multiple output regulator according to another embodiment of the present disclosure; and

FIG. 5 shows a schematic diagram of various signal for the single inductor multiple output regulator of FIG. 4.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

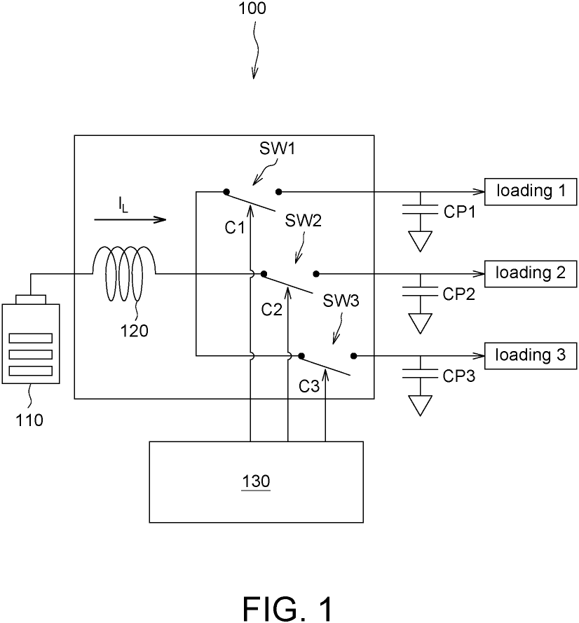

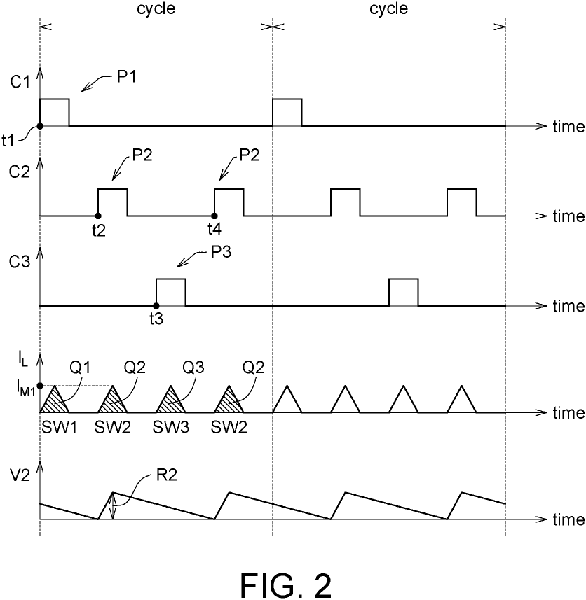

Referring to FIGS. 1 to 2, FIG. 1 shows a functional block diagram of a single inductor multiple output regulator 100 according to an embodiment of the present disclosure, and FIG. 2 shows a schematic diagram of various signal for the single inductor multiple output regulator 100 of FIG. 1.

The single inductor multiple output (SIMO) regulator 100 could be applied to stabilizer or other electronic device which needs multiple outputs.

The single inductor multiple output regulator 100 includes a power supplier 110, an inductor 120, a plurality of capacitors, a plurality of switches and a control circuit 130. In the present embodiment, the capacitors include a first capacitor CP1, a second capacitor CP2 and a third capacitor CP3, and the switches includes a first switch SW1, a second switch SW2 and a third switch SW3. In an embodiment, the first capacitor CP1, the second capacitor CP2 and the third capacitor CP3 have the same or different capacitances.

The power supplier 110 is electrically coupled with the inductor 120 for supplying an inductor current I_{L} to switches SW1 to SW3 through the inductor 120. The switches SW1 to SW3 are coupled with the capacitors CP1 to CP3. For example, the first switch SW1 is electrically coupled with the first capacitor CP1, the second switch SW2 is electrically coupled with the second capacitor CP2, and the third switch SW3 is electrically coupled with the third capacitor CP3. The control circuit 130 is coupled with the switches SW1 to SW3 and configured to apply at least two multi-switching pulses to a multi-pulse controlled one of the switches SW1 to SW3 in each cycle (or each period). In the present embodiment, the multi-pulse controlled one is, for example, the second switch SW2.

As shown in FIG. 2, C1 represents control signal supplying to the first switch SW1 by the control circuit 130, C2 represents control signal supplying to the second switch SW2 by the control circuit 130, C3 represents control signal supplying to the third switch SW3 by the control circuit 130, I_{L} represents the inductor current supplying to the inductor 120 by the power supplier 110, and V2 represents voltage output through the second switch SW2, wherein the maximum voltage is called a ripple R2.

In the present embodiment, the control circuit 130 applies two multi-switching pulses P2 to the second switch SW2 (the multi-pulse controlled one) in each cycle. In other words, during each/one cycle, the second switch SW2 are controlled to be turned on by two multi-switching pulses P2. As a result, compared with one switching pulse P with larger inductor current I_{L} for the second switches SW2 during one cycle, the ripple R2 of the present embodiment could be reduced.

The control circuit 130 is configured to apply the at least two multi-switching pulses at a plurality of multi-pulse time points and apply the single-switching pulse at a single-pulse time point, wherein the single-pulse time point is between the multi-pulse time points. Furthermore, as shown in FIG. 2, the control circuit 130 applies two multi-switching pulses P2 at the multi-pulse time points t2 and t4 respectively, and applies one single-switching pulse P3 at the single-pulse time point t3, wherein the single-pulse time point t3 is between the multi-pulse time points t2 and t4. In other words, the multi-switching pulses P2 could be separated by the single-switching pulse.

In addition, the multi-pulse time points and the single-pulse time point are completely separated from each other. Furthermore, as shown in FIG. 2, the multi-pulse time points t2 to t4 and single-pulse time point t3 are completely separated from each other. In addition, the control circuit 130 applies one single-switching pulse P1 at a single-pulse time point t1, wherein the multi-pulse time points t2 to t4 and single-pulse time points t1 and t3 are completely separated from each other, that is, in one/each cycle, all pulses are applied to the switches non-simultaneously.

The control circuit 130 is configured to apply the single-switching pulse to a single-pulse controlled one of the switches SW1 to SW3 in each cycle, wherein the number of the multi-switching pulses is greater than the number of the single-switching pulses. Furthermore, as shown in FIG. 2, the control circuit 130 applies one single-switching pulse P1 to the first switch SW1 (the single-pulse controlled one) and one single-switching pulse P3 to the third switch SW3 (the single-pulse controlled one), wherein the number of the multi-switching pulses P2 (the number is two) is greater than the number of the single-switching pulse P1 (the number is one), and the number of the multi-switching pulses P2 (the number is two) is greater than the number of the single-switching pulse P3 (the number is one).

In addition, in the present embodiment, as shown in FIG. 2, in one cycle, two times inductor current 2×I_{L} is evenly applied to the two multi-switching pulses P2, and thus each multi-switching pulses P2 with the inductor current 1×I_{L} is applied to the second switch SW2. As a result, the current peak I_{M1} of the inductor current I_{L} could be reduced, and accordingly it could increase the choices of the inductor 110.

In addition, compared with one multi-switching pulse P2 with the same inductor current I_{L} for the second switches SW2 during one cycle, the inductor current I_{L} (loading ability), in the present embodiment, is doubled (due to two pulses input in one cycle) without increasing output ripple.

In addition, as shown in FIG. 2, due to the inductor currents I_{L} for the first switch SW1, the second switch SW2 and the third switch SW3 being the same, the charge Q1 (Q1= capacitance of the first capacitor CP1×voltage of the first capacitor CP1) stored in the first capacitor CP1 during the conduction period of the first switch SW1, the charge Q2 (Q2=capacitance of the second capacitor CP2×voltage of the second capacitor CP2) stored in the second capacitor CP2 during the conduction period of the second switch SW2 and the charge Q3 (Q3=capacitance of the third capacitor CP3×voltage of the third capacitor CP3) stored in the third capacitor CP3 during the conduction periodof the third switch SW3 are the same, that is, Q1=Q2=Q3.

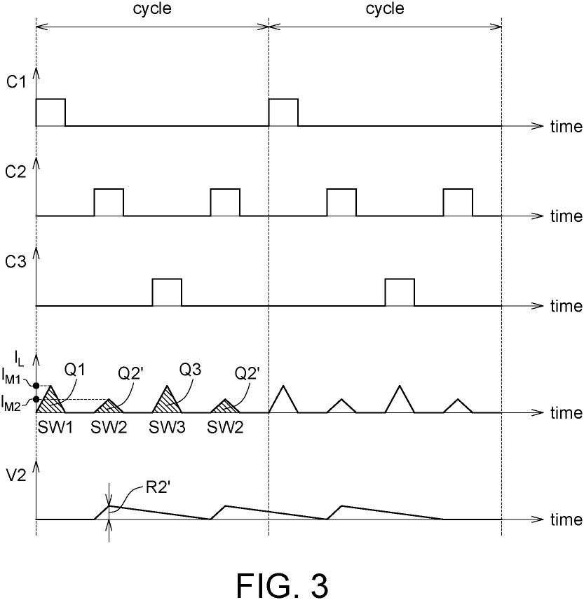

Referring to FIG. 3, FIG. 3 shows a schematic diagram of various signal for the single inductor multiple output regulator 100 of FIG. 1 according to another embodiment.

In the present embodiment, the inductor currents I_{L} for the first switch SW1, the second switch SW2 and the third switch SW3 being different. For example, the inductor current I_{L} supplied to the second switch SW2 is less than the inductor current I_{L} supplied to the first switch SW1 and is also less than the inductor current I_{L} supplied to the third switch SW3. Thus, the inductor current supplied to the second switch SW2 has current peak I_{M2}, the inductor current supplied to the first switch SW1 has current peak I_{M1}, and the inductor current supplied to the third switch SW3 has current peak I_{M1}, wherein the current peak I_{M2} is less than the current peak I_{M1}.

As shown in FIG. 3, due to the inductor current I_{L} supplied to the second switch SW2 being less than the inductor current I_{L} supplied to the first switch SW1, the charge Q2ʹ stored in the second capacitor CP2 during the conduction period of the second switch SW2 is less than the charge Q1 stored in the first capacitor CP1 during the conduction period of the first switch SW1, and the charge Q3 stored in the third capacitor CP3 during the conduction period of the third switch SW3, that is, Q2ʹ<Q1, and Q2ʹ<Q3.

As shown in FIG. 3, compared with the charge Q2 of FIG. 2, the charge Q2ʹ of FIG. 3 is reduced, and thus a ripple R2ʹ of FIG. 3 is less than the ripple R2 of FIG. 2. In other words, by controlling the inductor current I_{L} for the multi-pulse controlled one, it could change the ripple output through the multi-pulse controlled one.

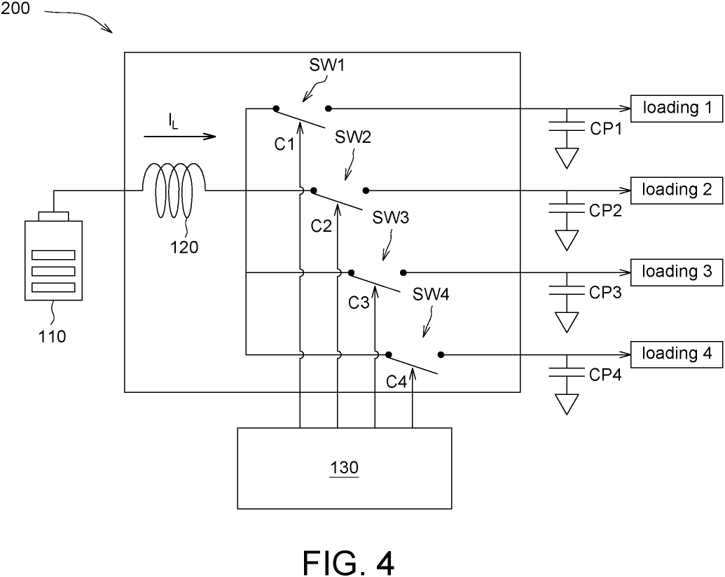

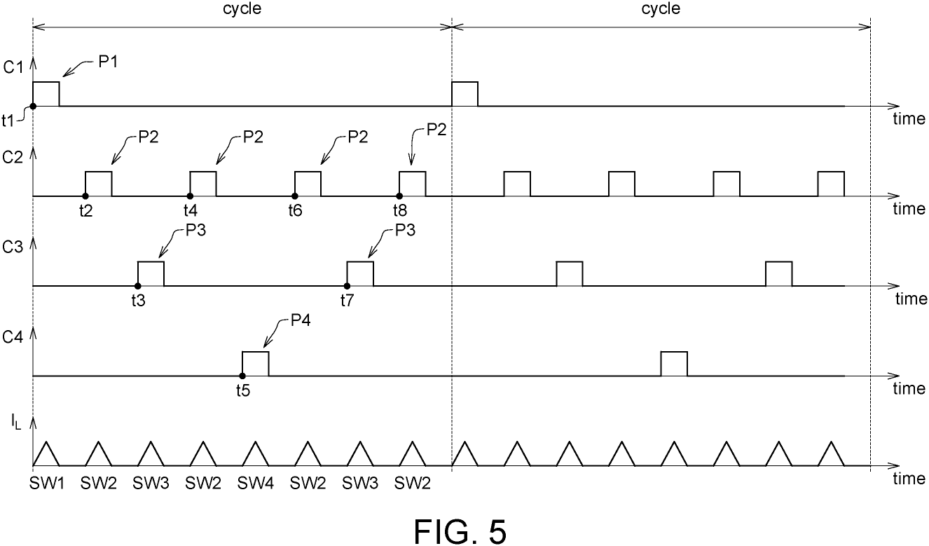

Referring to FIGS. 4 and 5, FIG. 4 shows a functional block diagram of a single inductor multiple output regulator 100 according to another embodiment of the present disclosure, and FIG. 5 shows a schematic diagram of various signal for the single inductor multiple output regulator 200 of FIG. 4.

The single inductor multiple output regulator 200 includes the power supplier 110, the inductor 120, a plurality of capacitors, a plurality of switches and the control circuit 130. In the present embodiment, the capacitors include the first capacitor CP1, the second capacitor CP2, the third capacitor CP3 and a fourth capacitor CP4, and the switches includes the first switch SW1, the second switch SW2, the third switch SW3 and a fourth switch SW4. In an embodiment, the first capacitor CP1, the second capacitor CP2, the third capacitor CP3 and the fourth capacitor CP4 have the same or different capacitances.

The power supplier 110 is electrically coupled with the inductor 120 for supplying an inductor current I_{L} to switches SW1 to SW4 through the inductor 120. The switches SW1 to SW4 are coupled with the capacitors CP1 to CP4. For example, the first switch SW1 is electrically coupled with the first capacitor CP1, the second switch SW2 is electrically coupled with the second capacitor CP2, the third switch SW3 is electrically coupled with the third capacitor CP3, and the fourth switch SW4 is electrically coupled with the fourth capacitor CP4. The control circuit 130 is coupled with the switches SW1 to SW4 and configured to apply at least two multi-switching pulses to a multi-pulse controlled one of the switches SW1 to SW4 in each cycle. In the present embodiment, the multi-pulse controlled one is, for example, the second switch SW2.

In the present embodiment, in each/one cycle, the number of the multi-switching pulses P2 for the second switch SW2 (the number is four) is greater than the number of the single-switching pulses P1 for the first switch SW1 (the number is one), and also the number of the multi-switching pulses P2 for the second switch SW2 is greater than the number of the single-switching pulses P4 for the fourth switch SW4 (the number is one).

The control circuit 130 is configured to apply the at least two multi-switching pulses at a plurality of multi-pulse time points and apply the single-switching pulse at a single-pulse time point, wherein the single-pulse time point is between the multi-pulse time points. Furthermore, as shown in FIG. 5, the control circuit 130 applies four multi-switching pulses P2 at a plurality of multi-pulse time points t2, t4, t6 and t8, and applies one single-switching pulse P4 at the single-pulse time point t5, wherein the single-pulse time point t5 is between the multi-pulse time points t4 and t6.

In addition, the control circuit 130 is configured to apply at least two multi-switching pulses to another multi-pulse controlled one of the switches SW1 to SW4 in each cycle. In the present embodiment, such another multi-pulse controlled one is, for example, the third switch SW3. The control circuit 130 applies at least two multi-switching pulses P3 to the third switch SW3 in each cycle.

As shown in FIG. 5, the control circuit 130 applies two multi-switching pulses P3 at the multi-pulse time points t3 and t7, wherein the single-pulse time point t5 is between the multi-pulse time points t3 and t7.

In one cycle, the number of the multi-switching pulses P3 for the third switch SW3 (the number is two) is greater than the number of the single-switching pulses P1 for the first switch SW1 (the number is one), and also the number of the multi-switching pulses P3 for the third switch SW3 is greater than the number of the single-switching pulses P4 for the fourth switch SW4 (the number is one).

In addition, the control circuit 130 is further configured to apply the at least two multi-switching pulses at a plurality of multi-pulse time points and apply the at least one multi-switching pulse at the multi-pulse time point, wherein the multi-pulse time point is between the multi-pulse time points. Furthermore, as shown in FIG. 5, the control circuit 130 applies four multi-switching pulses P2 at the multi-pulse time points t2, t4, t6 and t8, and applies two multi-switching pulses P3 at the multi-pulse time points t3 and t7, wherein the multi-pulse time point t3 is between the multi-pulse time points t2 and t4, and the multi-pulse time point t7 is between the multi-pulse time points t6 and t8.

As shown in FIG. 5, the multi-pulse time points t2, t4, t6 and t8, the multi-pulse time points t3 and t7, the single-pulse time point t1 and the single-pulse time point t5 are completely separated from each other, that is, in one/each cycle, all pulses are applied to the switches non-simultaneously.

In addition, in one cycle, the number of the multi-switching pulses P2 for the second switch SW2 is different from that of the multi-switching pulses P3 for the third switch SW3. For example, the number of the multi-switching pulses P2 for the second switch SW2 (the number is four) is greater than that of the multi-switching pulses P3 for the third switch SW3 (the number is two).

In summary, in the present embodiment, the single inductor multiple output regulator includes a plurality switches controlled by the control circuit. In one/each cycle (period), the control circuit applies a plurality of pulses to the switches at different time points, and at least one of the switches are applied with multi pulses, and at least one of the switches are applied with single pulse. Due to multi pulses being applied to at least one of the switches in one/each cycle, it could reduce the current peak of the inductor current, increase the choices of the inductor and/or reduce the ripple output.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A single inductor multiple output regulator, comprises:
an inductor;
a plurality of capacitors;
a plurality of switches coupled with the capacitors; and
a control circuit coupled with the switches and configured to apply at least two multi-switching pulses to a multi-pulse controlled one of the switches in each cycle.

2. The single inductor multiple output regulator according to claim 1, wherein the control circuit is further configured to:
apply a single-switching pulse to a single-pulse controlled one of the switches in each cycle, wherein the number of the multi-switching pulses is greater than the number of the single-switching pulse.

3. The single inductor multiple output regulator according to claim 2, wherein the control circuit is further configured to:
apply the at least two multi-switching pulses at a plurality of multi-pulse time points; and
apply the single-switching pulse at a single-pulse time point;
wherein the single-pulse time point is between the multi-pulse time points.

4. The single inductor multiple output regulator according to claim 3, wherein the multi-pulse time points and the single-pulse time point are completely separated from each other.

5. The single inductor multiple output regulator according to claim 1, further comprises:
a power supply coupled to the switches and configured to apply an inductor current to the switches through the inductor;
wherein the inductor current is applied to the multi-pulse controlled one is the same as that of the single-pulse controlled one.

6. The single inductor multiple output regulator according to claim 1, further comprises:
a power supply coupled to the switches and configured to apply an inductor current to the switches through the inductor;
wherein the inductor current applied to the multi-pulse controlled one is less than that of the single-pulse controlled one.

7. A control method, comprises:
providing a single inductor multiple output regulator, wherein the single inductor multiple output regulator comprises an inductor; a plurality of capacitors; a plurality of switches coupled with the capacitors; and a control circuit coupled with the switches; and
applying, by the control circuit, at least two multi-switching pulses to a multi-pulse controlled one of the switches in each cycle.

8. The control method according to claim 7, further comprising:
applying, by the control circuit, a single-switching pulse to a single-pulse controlled one of the switches in each cycle, wherein the number of the multi-switching pulses is greater than the number of the single-switching pulse.

9. The control method according to claim 8, further comprising:
applying, by the control circuit, the at least two multi-switching pulses at a plurality of multi-pulse time points; and
applying, by the control circuit, the single-switching pulse at a single-pulse time point;
wherein the single-pulse time point is between the multi-pulse time points.

10. The control method according to claim 9, wherein the multi-pulse time points and the single-pulse time point are completely separated from each other.

11. The control method according to claim 7, wherein the single inductor multiple output regulator further comprises a power supply coupled to the switches, and the control method further comprises:
applying, by the power supply, an inductor current to the switches through the inductor;
wherein the inductor current is applied to the multi-pulse controlled one is the same as that of the single-pulse controlled one.

12. The control method according to claim 7, wherein the single inductor multiple output regulator further comprises a power supply coupled to the switches, and the control method further comprises:
applying, the power supply, an inductor current to the switches through the inductor;
wherein the inductor current applied to the multi-pulse controlled one is less than that of the single-pulse controlled one.
